(19) United States
(12) Patent Application Publication
(10) Pub. No.: US 2025/0064073 A1
(43) Pub. Date: Feb. 27, 2025

(54) ALTERNATIVE PROTEIN CRUMBLES

(71) Applicant: Cargill, Incorporated, Wayzata, MN (US)

(72) Inventors: Andrea Renea English, Wichita, KS (US); Conor Sullivan, Hopkins, MN (US)

(73) Assignee: Cargill, Incorporated, Wayzata, MN (US)

(21) Appl. No.: 18/724,797

(22) PCT Filed: Jan. 12, 2023
(86) PCT No.: PCT/US2023/060539

§ 371 Date: Jun. 27, 2024

Related U.S. Application Data
(60) Provisional application No. 63/299,139, filed on Jan. 13, 2022.

(51) Int. Cl. A23L 3/3472; A23J 3/14; A23J 3/16; A23J 3/18; A23J 3/22

(52) U.S. Cl. CPC A23L 3/3472; A23J 3/14; A23J 3/16; A23J 3/18; A23J 3/227

(57) ABSTRACT

The present technology provides a method for extending the shelf-life of a cooked meat substitute. The method includes adding a shelf-life extending agent that includes konjac gum, psyllium fiber, or mixtures thereof to a non-meat protein to obtain a meat substitute; and cooking the meat substitute to obtain the cooked meat substitute; wherein the refrigerated shelf-life of the cooked meat substitute is longer than a cooked meat substitute that does not include the shelf-life extending agent.

### CROSS-REFERENCE TO RELATED APPLICATIONS

This application claims the benefit of U.S. Provisional Application No. 63/299,139, filed Jan. 13, 2022, which is incorporated by reference herein in its entirety.

### TECHNICAL FIELD

The present technology relates to method of extending the refrigerated shelf-life of meat substitutes. In particular, the present technology relates to a method of extending the refrigerated shelf-life of a meat substitute by using a shelf-life extending agent that includes konjac gum, psyllium fiber, or mixtures thereof, and meat substitutes and food items thereof.

### BACKGROUND

Demand for plant-based meat substitutes is increasing for a variety of reasons. Many consumers prefer meat substitute options that perform most similarly to animal meat. This demand includes cooked food items containing or made from meat substitutes, such as meat crumbles, pizza toppings, and sausage. However, cooked meat substitute food products generally have a limited refrigerated shelf-life. The shelf-life of a food product is critical to its success in the marketplace and is a key issue for consumer safety, product quality, and profitability.

Accordingly, there is an ever-growing need to have cooked meat substitutes having a refrigerated shelf-life as described herein.

### SUMMARY

In various aspects, the present technology provides a method for extending the shelf-life of a cooked meat substitute. The method includes:
adding a shelf-life extending agent that includes konjac gum, psyllium fiber, or mixtures thereof to a non-meat protein to obtain a meat substitute; and
cooking the meat substitute to obtain the cooked meat substitute;
wherein the refrigerated shelf-life of the cooked meat substitute is longer than a cooked meat substitute that does not include the shelf-life extending agent.

In various aspects, the present technology provides a food product that includes or is made from the cooked meat substitute as described herein. For example, the food product may include, but is not limited to, meat crumbles, pizza toppings, sausage, deli meat, burrito/taco filling, or hot dogs.

In various aspects, the present technology provides a cooked meat substitute that includes a non-meat protein; and about 0.5 wt % to about 5 wt % of a shelf-life extending agent, based on total weight of the meat substitute, where the shelf-life extending agent is includes konjac gum, psyllium fiber, or a mixture thereof; and the refrigerated shelf-life of the cooked meat substitute is longer than a cooked meat substitute that does not include the shelf-life extending agent.

In various aspects, the present technology provides a food item that includes the cooked meat substitute as described herein. The food item may include, but is not limited to, meat crumbles, pizza toppings, sausage, deli meats, burrito/taco filling, or hot dogs. Preferably, the food item is a meat crumble.

In various aspects, the present technology provides a method for preparing a cooked meat substitute. The method includes:
adding a shelf-life extending agent that includes konjac gum, psyllium fiber, or mixtures thereof to a non-meat protein to obtain a meat substitute; and
cooking the meat substitute to obtain a cooked meat substitute:
wherein:
the meat substitute includes about 0.5 wt % to about 5 wt % of a shelf-life extending agent, based on total weight of the meat substitute; and
the cooked meat substitute has a refrigerated shelf-life longer than a cooked meat substitute without the shelf-life extending agent.

### BRIEF DESCRIPTION OF THE DRAWINGS

FIG. 1A illustrates the structural refrigerated shelf-life of comparative alternative (i.e., plant) based meat crumbles without konjac gum at day 11, as described in Example 1.

FIG. 1B illustrates the structural refrigerated shelf-life of alternative (i.e., plant) based meat crumbles containing 1.9 wt % konjac gum at day 11, as described in Example 1.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter. One aspect described in conjunction with a particular embodiment is not necessarily limited to that embodiment and can be practiced with any other embodiment(s).

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

Nothing in the cited references teaches or suggests the claimed process. In addition, it is to be understood that the phraseology or terminology employed herein, and not otherwise defined, is for the purpose of description only and not of limitation. Any use of section headings is intended to aid reading of the document and is not to be interpreted as limiting: information that is relevant to a section heading may occur within or outside of that particular section.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

In the methods described herein, the acts can be carried out in a specific order as recited herein. Alternatively, in any embodiment disclosed herein, specific acts may be carried out any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, plus or minus within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the following terms have the following meanings unless expressly stated to the contrary.

As used herein, the terms “meat substitute,” “meat substitute composition,” “alternative protein composition,” “meat analogue,” “meat alternative,” “meat alternative composition,” “plant-based meat,” “cell-based meat” and the like refers to compositions that try to mimic the general appearance, nutritional content, and/or taste of natural animal meat or meat compositions without containing naturally occurring animal muscle cells or other types of animal cells typically associated with natural animal meat. The term “meat substitutes” and the like refer to a composition that includes plant-based or fungal-based meat substitutes, such as those based on pea protein, soy protein, wheat protein, chickpeas, or other types of plant proteins or mixtures of plant proteins, and/or those based on mushrooms or other fungal sources. The terms “meat substitute” and the like also include cell-based meat substitutes, i.e., compositions based on animal cells that are produced via fermentation, cell cultures, or other artificial methods. The terms “meat substitute” and the like also include compositions based on insect protein. The terms “meat substitute” and the like also include hybrid compositions that contain a combination of plant-based, insect-based, and/or fungal-based protein in combination with animal cells, including cultured animal cells (i.e., cell-based meat).

As used herein, the term “non-meat protein” refers to protein sourced from plants, fungus, insects, or cultured animal cells.

As used herein, the term “shelf-life” refers to the period of time under defined conditions of storage, after manufacture or packing, for which a food product will remain safe and be fit. For example, in some aspects “shelf-life” refers to the period in which a food product, such as a cooked meat substitute, should retain its desired sensory, chemical, physical, functional or microbiological characteristics when stored according to the recommended conditions. Typically, the term “shelf-life” refers to one or more of a microbiological shelf-life, a chemical shelf-life, a functional shelf-life, and an organoleptic shelf-life for a food product. In various aspects of the present invention, the shelf-life as defined herein refers to the shelf-life of the cooked meat substitute and food items thereof.

As used herein, the term “refrigerated shelf-life” refers to the shelf-life under typical refrigeration temperatures. Typically, refrigeration temperatures may be at or below about 40° F. (˜4.4° C.). For example, refrigeration temperatures may include, but are not limited to about 34° F. (˜1.1° C.), about 35° F. (˜1.6° C.), about 36° F. (˜2.2° C.), about 37° F. (˜2.8° C.), about 38° F. (˜3.3° C.), about 39° F. (˜3.9° C.), about 40° F. (˜4.4° C.), or any range including and/or in between any two of the preceding values, such as about 34 to about 38° F. (about 1.1-3.3° C.).

As used herein, the term “shelf-life extending agent” refers to an agent that is suitable for human consumption and extends the shelf-life of a cooked meat substitute.

Described herein are methods for extending the refrigerated shelf-life of a cooked meat substitute, and cooked meat substitutes and food items thereof. Refrigerated food products made from cooked meat substitutes such as meat crumbles, pizza toppings, sausage, etc. typically do not maintain their structural integrity during refrigerated shelf-life and mass together or fall apart completely. Previously, there was a limited refrigerated shelf-life for various food products made from cooked meat substitutes (e.g., meat crumbles, pizza toppings, or sausage), and such food products required storage at freezer temperatures (e.g., at or below about 32° F. (0° C.)). Over time, such products would lose structural integrity and clump and/or stick together when refrigerated. The present inventors surprisingly discovered the inclusion of konjac gum and/or psyllium fiber as shelf-life extending agents improved the refrigerated shelf-life (e.g., functional shelf-life, microbial shelf-life, and organoleptic shelf-life).

In various aspects, the present technology provides a method for extending the shelf-life of a cooked meat substitute. The method includes:
adding a shelf-life extending agent that includes konjac gum, psyllium fiber, or mixtures thereof to a non-meat protein to obtain a meat substitute; and
cooking the meat substitute to obtain the cooked meat substitute:
wherein the refrigerated shelf-life of the cooked meat substitute is longer than a cooked meat substitute that does not include the shelf-life extending agent.

Prior to the present invention, cooked meat substitutes and food products thereof required storage at freezer temperatures and had no refrigerated shelf-life. As described herein, the method may extend the refrigerated shelf-life of the cooked meat substitute to about 6 days to about 2 weeks, preferably about 1 week to about 1.5 weeks. For example, the method may extend refrigerated shelf-life of the cooked meat substitute to about 6 days, about 7 days, about 8 days, about 9 days, about 10 days, about 11 days, about 12 days, about 13 days, about 14 days, or any range including and/or in between any two of the preceding values.

The method may include adding the shelf-life extending agent to the non-meat protein at an amount of about 0.5 wt % to about 5 wt % of the shelf-life extending agent based on total weight of the meat substitute. For example, the shelf-life extending agent may be added in an amount of about 0.5 wt % to about 5 wt %, about 1 wt % to about 4 wt %, about 1.5 wt % to about 2.5 wt %, or about 1.7 wt % to about 2.3 wt % based on total weight of the meat substitute. Suitable amounts of the shelf-life extending agent may be about 0.5 wt %, about 1.0 wt %, about 1.5 wt %, about 2.0 wt %, about 2.5 wt %, about 3.0 wt %, about 3.5 wt %, about 4.0 wt %, or any range including and/or in between any two of the preceding values.

As described herein, the shelf-life extending agent may be konjac gum. Konjac gum is the water-soluble hydrocolloid obtained from konjac flour, which is an unpurified raw product from the root of the perennial plant Amorphophallus konjac, by aqueous extraction. Konjac gum is the water soluble high-molecular weight (e.g., about 200,000 to about 2,000,000 Da) polysaccharide glucomannan, which consists of D-mannose (M) and D-glucose (G) units. Typically, the konjac gum as described herein may have glucomannan units with a G to M ratio of about 1 to about 1.6.

The shelf-life extending agent may be psyllium fiber. Psyllium fiber is a soluble fiber obtained from Plantaginis ovatae or afra. The shelf-life extending agent may be a mixture of konjac gum and psyllium fiber.

As described herein, the non-meat protein may be a plant-based, fungal-based, insect-based, cultured animal cell-based protein, or mixtures thereof. Preferably, the non-meat protein may be a plant-based protein. Typically, the plant-based protein may include pea protein, soy protein, wheat protein, or mixtures thereof.

The cooking may include thermal screw cooking, batching cooking, continuous cook line cooking, kettle cooking, or combinations thereof.

In various aspects, the present technology provides a food product that includes or is made from the cooked meat substitute as described herein. For example, the food product may include, but is not limited to, meat crumbles, pizza toppings, sausage, deli meat, burrito/taco filling, or hot dogs.

In various aspects, the present technology provides a cooked meat substitute that includes a non-meat protein; and about 0.5 wt % to about 5 wt % of a shelf-life extending agent, based on total weight of the meat substitute, where the shelf-life extending agent is includes konjac gum, psyllium fiber, or a mixture thereof; and the refrigerated shelf-life of the cooked meat substitute is longer than a cooked meat substitute that does not include the shelf-life extending agent.

The cooked meat substitute may include the shelf-life extending agent in an amount of about 0.5 wt % to about 5 wt % based on total weight of the meat substitute. For example, the cooked meat substitute may include the shelf-life extending agent in amounts of about 0.5 wt % to about 5 wt %, about 1 wt % to about 4 wt %, about 1.5 wt % to about 2.5 wt %, or about 1.7 wt % to about 2.3 wt % based on total weight of the meat substitute. Suitable amounts of the shelf-life extending agent may be about 0.5 wt %, about 1.0 wt %, about 1.5 wt %, about 2.0 wt %, about 2.5 wt %, about 3.0 wt %, about 3.5 wt %, about 4.0 wt %, or any range including and/or in between any two of the preceding values.

The shelf-life extending agent may be konjac gum as described herein. Alternatively, the shelf-life extending agent may be psyllium fiber as described herein. The shelf-life extending agent may be a mixture of konjac gum and psyllium fiber.

The cooked meat substitute may have a refrigerated shelf-life of about 6 days to about 2 weeks, preferably about 1 week to about 1.5 weeks. Typically, the cooked meat substitute may have a refrigerated shelf-life of about 6 days, about 7 days, about 8 days, about 9 days, about 10 days, about 11 days, about 12 days, about 13 days, about 14 days, or any range including and/or in between any two of the preceding values.

As described herein, the non-meat protein may be a plant-based, fungal-based, insect-based, cultured animal cell-based protein, or mixtures thereof. Preferably, the non-meat protein may be a plant-based protein. Typically, the plant-based protein may include pea protein, soy protein, wheat protein, or mixtures thereof.

The cooking may include thermal screw cooking, batching cooking, continuous cook line cooking, kettle cooking, or combinations thereof.

In various aspects, the present technology provides a food item that includes the cooked meat substitute as described herein. The food item may include, but is not limited to, meat crumbles, pizza toppings, sausage, deli meats, burrito/taco filling, or hot dogs. Preferably, the food item is a meat crumble.

In various aspects, the present technology provides a method for preparing a cooked meat substitute. The method includes:
adding a shelf-life extending agent that includes konjac gum, psyllium fiber, or mixtures thereof to a non-meat protein to obtain a meat substitute; and
cooking the meat substitute to obtain a cooked meat substitute:
wherein:
the meat substitute includes about 0.5 wt % to about 5 wt % of a shelf-life extending agent, based on total weight of the meat substitute; and
the cooked meat substitute has a refrigerated shelf-life longer than a cooked meat substitute without the shelf-life extending agent.

The present invention, thus generally described, will be understood more readily by reference to the following examples, which are provided by way of illustration and are not intended to be limiting of the present invention.

### EXAMPLES

Example 1: Preparation of Plant-based Meat Crumbles. A 20-g sample of alternative (i.e., plant-based) meat crumbles containing 1.9 wt % of konjac gum or 1.9 wt % of psyllium fiber were prepared via thermal screw and immediately frozen. Each plant-based meat crumble sample was refrigerated and stored at a temperature of about 34-38° C. An aliquot of the sample was removed for microbiological and organoleptic shelf-life evaluation over an 11-day period. Additionally, a comparative 20-g sample of a meat-based (beef) crumble was also prepared via thermal screw for refrigerated shelf-life evaluation over an 11-day period.

TABLE 1
Microbiological Shelf-Life (stored 34-38° F. (1.1-3.3° C.))

| | 0 | 2 | 4 | 6 | 9 | 11 |
|---|---|---|---|---|---|---|
| Sample | days | days | days | days | days | days |
| | TPC* (Log cfu/g) | | | | | |
| Meat-based crumble | 3.70 | 3.4 | 3.70 | 3.41 | 3.70 | 3.40 |
| Konjac gum (1.9 wt %) | 4.1 | 4.3 | 3.8 | 4.0 | 4.0 | 4.0 |
| Psyllium fiber (1.9 wt %) | 3.9 | 3.9 | 4.1 | 4.2 | 4.2 | 4.2 |
| | EB (Log cfu/g) | | | | | |
| Meat-based crumble | <1.00 | <1.00 | <1.00 | <1.00 | <1.00 | <1.00 |
| Konjac gum (1.9 wt %) | <1.00 | <1.00 | <1.00 | <1.00 | <1.00 | <1.00 |
| Psyllium fiber (1.9 wt %) | <1.00 | <1.00 | <1.00 | <1.00 | <1.00 | <1.00 |

*TPC = total plate count
**EB = enterobacteriaceae

As shown in Table 1, meat crumble samples containing konjac gum and psyllium fiber exhibited acceptable microbiological levels over an 11-day refrigerated storage period. In particular, meat crumble samples containing 1.9 wt % konjac gum had an APC of <4.5 log cfu/g, and meat crumble samples containing 1.9 wt % psyllium fiber had an APC of ≤4.0 log cfu/g. Typically, TPC having achieved/exceeded 7.00 log cfu/g is not a direct indicator of product spoilage. However, as the TPC approaches this level, the likelihood of organoleptic spoilage increases significantly.

Enterobacteriaceae levels remained undetectable (<1.00) for meat crumble samples containing 1.9 wt % konjac gum and psyllium fiber. EB or Generic Coliform and E. coli (ECC) quality indicator organisms having achieved/exceeded 6.0 logs (cfu/g) in raw ground beef and ground turkey/chicken encroaches on the USDA ‘Appendix A’ Salmonella Time-Temperature guidelines (USDA/CFIA ‘Appendix A’ Salmonella Time-Temperature Cooking Guidelines) that state cooking to an internal temperature of 158-160° F. (70-71.1° C.) offers an “instant” 6.5-7.0 log cfu/g reduction and an internal temperature of 165° F. offers an “instant” 7.0 log cfu/g reduction, respectively.

TABLE 2
Organoleptic Shelf-Life

| | 0 | 2 | 4 | 6 | 9 | 11 |
|---|---|---|---|---|---|---|
| Sample | days | days | days | days | days | days |
| | Odor | | | | | |
| Meat-based crumble | 6 | 6 | 6 | 6 | 6 | 6 |
| Konjac gum (1.9 wt %) | 6 | 6 | 6 | 6 | 6 | 6 |
| Psyllium fiber (1.9 wt %) | 6 | 6 | 6 | 6 | 6 | 6 |
| | Color | | | | | |
| Meat-based crumble | 8 | 8 | 8 | 8 | 8 | 8 |
| Konjac gum (1.9 wt %) | 8 | 8 | 8 | 8 | 8 | 8 |
| Psyllium fiber (1.9 wt %) | 8 | 8 | 8 | 8 | 8 | 8 |

As shown in Table 2, meat crumble samples containing 1.9 wt % konjac gum and psyllium fiber, respectively, exhibited color and odor scores within the “highly acceptable range” throughout the 11-day duration of the refrigerated shelf-life storage period, which was comparable to the comparative meat-based sample. To conduct the organoleptic evaluation, a benchtop sensory evaluation was conducted for each sample. At the time points provided in Table 2, each sample was evaluated based upon odor immediately after opening packages and visual color.

Odor evaluation was graded according to the following scale.

| | |
|---|---|
| 6 | No odor (unless product contains spices with acceptable odor) |
| 5 | Slight odor (odor dissipates quickly) |
| 4 | Slight odor remains (would still eat) |
| 3 | Slight odor remains (would not eat) |
| 2 | Moderate off-odor |
| 1 | Strong offensive off color |

Visual color evaluation was graded according to the following scale (Total Discoloration Scale.

| | |
|---|---|
| 8 | Extremely desirable or acceptable; no discoloration (0%) |
| 7 | Very desirable or acceptable; slight discoloration (1-14%) |
| 6 | Moderately desirable or acceptable; small discoloration (15-29%) |
| 5 | Slightly desirable or acceptable (still would eat); modest |
| | discoloration (30-44%) |
| 4 | Slightly undesirable or unacceptable (would not eat); moderate |
| | discoloration (45-59%) |
| 3 | Moderately undesirable or unacceptable; extensive discoloration |
| | (60-74%) |
| 2 | Very undesirable or unacceptable; extreme discoloration (75-89%) |
| 1 | Extremely undesirable or unacceptable; total discoloration (90-100%) |

As shown in Table 2, meat crumbles prepared according to Example 1 exhibited the highest odor and visual color ratings (i.e., most acceptable) throughout the entire refrigerated shelf-life evaluation period. Accordingly, the examples demonstrate the plant-based meat crumbles provide a refrigerated shelf-life comparable to meat-based samples.

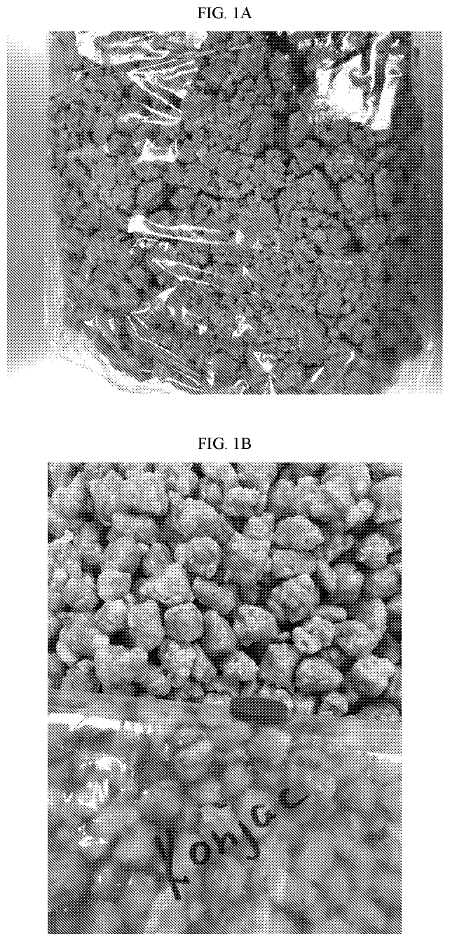

Additionally, alternative meat-based crumbles containing 1.9 wt. % of konjac gum exhibited improved structural integrity (i.e., structural shelf-life) over the 11-day refrigerated shelf-life evaluation period. The experimental sample (konjac gum) prepared according to Example 1 and a comparative alternative (i.e., plant-) based meat crumble that does not contain konjac gum were evaluated for structural refrigerated shelf-life at 34-38° F. As shown in FIG. 1A (day 11—without konjac gum), the comparative sample (without konjac gum) exhibited a significant loss in structural integrity after 11 days of refrigerated storage. In contrast, FIG. 1B (day 11—with konjac gum) showed the experimental sample (with 1.9 wt % konjac gum) maintained structural integrity after 11 days of refrigerated storage.

Each of the non-limiting aspects above can stand on its own or can be combined in various permutations or combinations with one or more of the other aspects or other subject matter described in this document. While certain aspects have been illustrated and described, a person with ordinary skill in the art, after reading the foregoing specification can effect changes, substitutions of equivalents and other types of alterations to the present technology as set forth herein. Each aspect and embodiment described above can also have included or incorporated therewith such variations or aspects as disclosed in regard to any or all of the other aspects and embodiments.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

The embodiments, illustratively described herein may suitably be practiced in the absence of any element or elements, limitation or limitations, not specifically disclosed herein. Thus, for example, the terms “comprising.” “including.” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

What is claimed is:

1. A method for extending the refrigerated shelf-life of a cooked meat substitute, the method comprising:
adding a shelf-life extending agent comprising konjac gum, psyllium fiber, or mixtures thereof to a non-meat protein to obtain a meat substitute; and
cooking the meat substitute to obtain the cooked meat substitute;
wherein the refrigerated shelf-life of the cooked meat substitute is longer than a cooked meat substitute that does not include the shelf-life extending agent.

2. The method of claim 1, wherein the refrigerated shelf-life of the cooked meat substitute is about 6 days to about 2 weeks.

3. (canceled)

4. The method of claim 1, wherein the meat substitute comprises about 0.5 weight percentages (wt %) to about 5 wt % of the shelf-life extending agent based on total weight of the meat substitute.

5.-6. (canceled)

7. The method of claim 1, wherein the shelf-life extending agent is konjac gum.

8. The method of claim 1, wherein the konjac gum comprises glucomannan units with a G to M ratio of about 1 to about 1.6.

9. The method of claim 1, wherein the shelf-life extending agent is psyllium fiber.

10. The method of claim 1, wherein the non-meat protein is a plant-based protein.

11. The method of claim 10, wherein the plant-based protein comprises pea protein, soy protein, wheat protein, or mixtures thereof.

12. The method of claim 1, wherein the cooking comprises thermal screw cooking, batching cooking, continuous cook line cooking, kettle cooking, or combinations thereof.

13. A food product comprising the cooked meat substitute prepared according to the method of claim 1.

14. A cooked meat substitute comprising:
a non-meat protein; and
about 0.5 wt % to about 5 wt % of a shelf-life extending agent, based on total weight of the meat substitute;
wherein:
the shelf-life extending agent comprises konjac gum, psyllium fiber, or a mixture thereof; and
the refrigerated shelf-life of the cooked meat substitute is longer than a cooked meat substitute that does not include the shelf-life extending agent.

15.-16. (canceled)

17. The cooked meat substitute of claim 14, wherein the shelf-life extending agent is konjac gum or psyllium fiber.

18. The cooked meat substitute of claim 14, wherein the konjac gum comprises glucomannan units with a G to M ratio of about 1 to about 1.6.

19. (canceled)

20. The cooked meat substitute of claim 14, wherein the meat substitute has a refrigerated shelf-life of about six days to about 2 weeks.

21. (canceled)

22. The cooked meat substitute of claim 14, wherein the non-meat protein is a plant-based protein.

23. The cooked meat substitute of claim 22, wherein the plant-based protein comprises pea protein, soy protein, wheat protein, or mixtures thereof.

24. The cooked meat substitute of claim 14, wherein the cooked meat substitute is cooked via thermal screw, batching cooking, continuous cook line cooking, kettle cooking, or combinations thereof.

25. A food item comprising the cooked meat substitute of claim 14.

26. The food item of claim 25, wherein the food item comprises pizza toppings, meat crumbles, or sausage.

27. (canceled)

28. A method for preparing a cooked meat substitute, the method comprising:
adding a shelf-life extending agent comprising konjac gum, psyllium fiber, or mixtures thereof to a non-meat protein to obtain a meat substitute; and
cooking the meat substitute to obtain a cooked meat substitute;
wherein:
the meat substitute comprises about 0.5 wt % to about 5 wt % of a shelf-life extending agent, based on total weight of the meat substitute; and
the food item has a refrigerated shelf-life longer than a food item prepared from a cooked meat substitute without the shelf-life extending agent.
